(19) United States
(12) Patent Application Publication
(10) Pub. No.: US 2016/0262070 A1
(43) Pub. Date: Sep. 8, 2016

(54) A METHOD FOR MANAGING A LOW LATENCY HANDOVER FOR MOBILE HOST SEAMLESS MOBILITY

(71) Applicant: UNIVERSITI PUTRA MALAYSIA, Upm Serdang, Selangor (MY)

(72) Inventors: Mohamed OTHMAN, Serdang (MY); Ibrahim AL-SURMI, Serdang (MY)

(21) Appl. No.: 15/028,706

(22) PCT Filed: Oct. 9, 2014
(86) PCT No.: PCT/MY2014/000249

§ 371 Date: Apr. 11, 2016

(30) Foreign Application Priority Data
Oct. 11, 2013 (MY) PI 2013701938

(51) Int. Cl. H04W 36/18; H04W 36/00; H04W 60/00; H04W 36/22; H04W 12/06

(52) U.S. Cl. CPC H04W 36/18; H04W 36/22; H04W 12/06; H04W 60/00; H04W 36/0033

(57) ABSTRACT

The present invention relates to a method for managing a low latency of handover of MH comprising the steps of: determining imminence handover of the MH whether intra-domain or inter-domain using hybrid location tracking scheme (100); initiating an intra-domain handover mechanism (200) if the handover is the intra-domain handoverthrough transmitting the MH's context transfer towards multiple new MAG domain based on MCE list; initiating an inter-domain handover mechanism (300) if the handover is the inter-domain handover-through transmitting the MH's context transfer towards multiple fLMA domain based on the HLCE list; and redirecting all traffic towards the MH (400). The above provision is advantageous as it provides a hybrid latency low intra/inter-domain handover mechanism, which proactively coordinates MH's handover process as well as maintains MH's data session continually during its intra/inter-domain roaming within/across PMIPv6 domain respectively.

### FIELD OF INVENTION

The present invention relates to a method for managing a seamless handover of a MH in wireless network framework.

### BACKGROUND OF THE INVENTION

Recently, IETF proposed another protocol like Proxy Mobile IPv6 (PMIPv6) as a network-based mobility management approach to overcome the most Internet Protocol (IP) mobility challenge and support the Mobile Host (MH) mobility roaming within a localized domain network (i.e., intra-domain mobility/horizontal handover). In addition, PMIPv6 assign network entities to carry out the mobility-related signaling on behalf of the MH and shortens these signaling by form of the localized domain during MH intra-domain handover. Therefore, it allows diverse type of MHs to utilize the PMIPv6 services with less IP-stack complexity and power uses as well as saving the air resource (i.e., lessens the mobility signaling over the wireless link). Nevertheless, although PMIPv6 mobility management performs superior than the MIPv6 and its extensions it cannot support MH inter-domain mobility, since its primary designed for MH intra-domain mobility. Thus, when MH moves out across PMIPv6 domain edge will incur a connection disruption, which disables the continuity of its communication session.

In addition, in future high-speed mobility environment (i.e., train, vehicle, etc.)

providing anywhere and anytime Internet accesses for real-time sensitive service becomes an important issue. This can be achieved using IP mobility management protocol like PMIPv6. Accordingly, in order to support IP mobility with service continuity for high-speed environments. PMIPv6 have to provide a seamless handover scheme and utilize the geographical position information of the base stations access links. Since, the typical high-speed mobility host moves with considerable distance at very high-speed movements, which usually restricted to directional/bidirectional movement along the pathways.

Concerns have been raised by several relevant conventional inter-PMIPv6-domain schemes about supporting MH inter-domain mobility. However these schemes lack to support an efficient seamless handover for MH mobility roaming both in intra/inter-domain. Due to their considerable handover latency, data traffic losses, extra mobility-related signaling and high end-to-end traffic latency. Hence, these issues negatively impede the performance requirements to satisfy the Quality of Service (QoS) for the real-time sensitive services towards providing uninterrupted network connectivity.

### SUMMARY OF THE INVENTION

According to an aspect of the present invention, the present invention provides a method for managing a low latency of handover of MH comprising the steps of: determining imminence handover of the MH whether intra-domain or inter-domain using hybrid location tracking scheme (100); initiating an intra-domain handover mechanism (200) if the handover is the intra-domain handoverthrough transmitting the MH's context transfer towards multiple new Mobile Access Gateway (MAG) domain based on MCE cache list; initiating an inter-domain handover mechanism (300) if the handover is the inter-domain handoverthrough transmitting the MH's context transfer towards multiple foreign Local Mobility Anchor (fLMA) domain based on the HLCE cache list; and redirecting all traffic towards the MH (400).

The above provision is advantageous as it provides a hybrid latency low intra/inter-domain handover mechanism, which proactively coordinates MH's handover process as well as maintains MH's data session continually during its intra/inter-domain roaming within/across PMIPv6 domain respectively.

The present invention introduces an intermediate hybrid mobility anchor entity, called intermediate Hybrid Local Mobility Anchor (iHLMA), which is responsible to manage and coordinate MH inter-domain mobility as well as redirect MH's data traffic towards PMIPv6 domains.

Furthermore, the present invention provides a proactive intra/inter location registration along with access authentication tightly together in advance the MH roaming towards target intra/inter-domain access links as soon it is notified about the MH imminent handover either within or across an intra/inter-domain boundary, respectively. This process can be identified by means of the hybrid location tracking mechanism. Thus, as soon the MH attaches to any pre-informed neighbour location, it can re-configure its interface more quickly and resume its data session.

### BRIEF DESCRIPTION OF THE DRAWINGS

FIG. 1 illustrates a flowchart of the method for managing a low latency handover for MH seamless mobility of the present invention.

FIG. 2 illustrates a network structure of location tracking of the handover of the MH of the present invention

FIG. 3 illustrates message flows of an intra-domain handover of the present invention.

FIG. 4 illustrates message flows of an inter-domain handover of the present invention.

### DETAILED DESCRIPTION OF THE PREFERRED EMBODIMENT

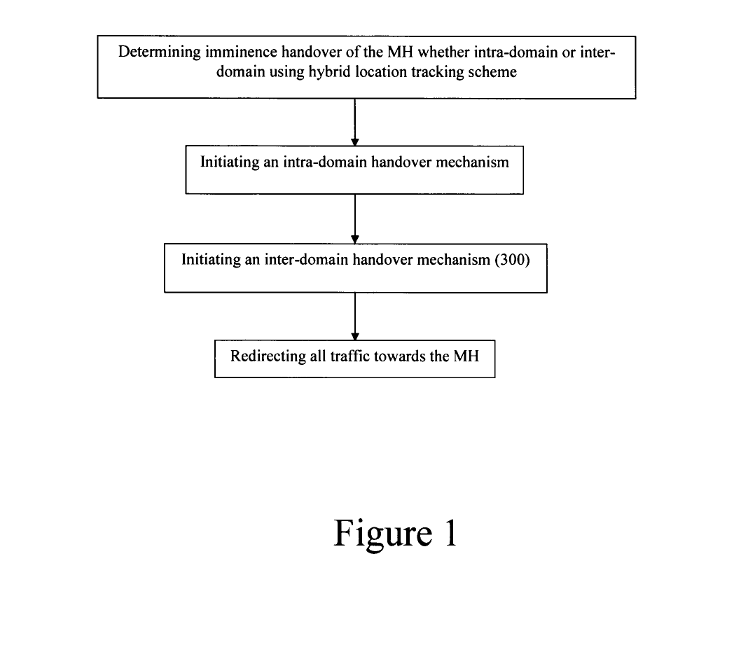

Generally, the present invention relates to a method for managing a low latency of handover of MH comprising the steps of: determining imminence handover of the MH whether intra-domain or inter-domain using hybrid location tracking scheme (100); initiating an intra-domain handover mechanism (200) if the handover is the intra-domain handoverthrough transmitting the MH's context transfer towards multiple new MAG domain based on MCE cache list; initiating an inter-domain handover mechanism (300) if the handover is the inter-domain handoverthrough transmitting the MH's context transfer towards multiple fLMA domain based on the HLCE cache list; and redirecting all traffic towards the MH (400). The general step of the handover process of the present invention is illustrated in FIG. 1.

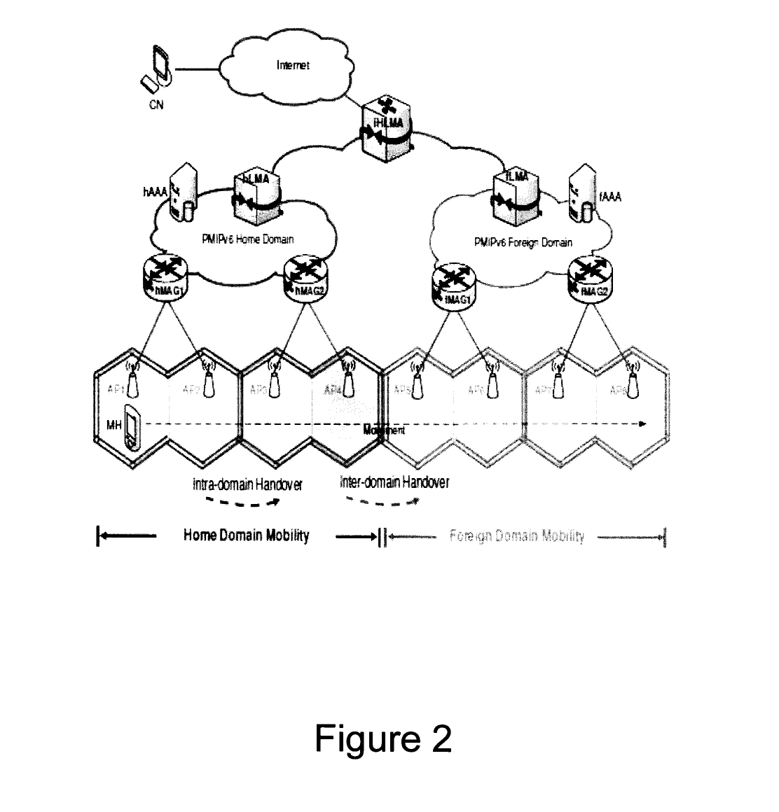

To understand figuratively the network structure of location tracking of the handover of the MH of the present invention, it is illustrated in FIG. 2.

The steps of initiating an intra-domain handover mechanism (200) further comprising: sending a De-Reg PBU message from home Mobile Access Gateway (hMAG) access link to home Local Mobility Anchor (hLMA) (201); activating proactive intra-domain pre-registration and access authentication in advance of MH actual detachment by sending a PBAck message from the hLMA comprising the MH's profile with authentication information along with setting up one-way tunnel towards new hMAGs neighbours based on the MCE list (202); bypass the access authentication by the new hMAG whenever it detects the MH attachments by comparing the MH-ID and MHHNP with the pre-registered MH's profile (203); updating MH's BUL entry and sending a quick RtrAdv message with same MH-HNP by the new hMAG towards the MH to re-configure its interface to quickly resume its data session if matched (204); sending the PBU message by the new hMAG to the hLMA indicating to complete MH's location update (205); and setting up a reverse endpoint tunnel by the new hMAG towards the hLMA offering MH's traffic access (206).

The steps of initiating an inter-domain handover mechanism (300) further comprising: sending a De-Reg PBU message from the hMAG to the hLMA whenever the hMAG senses the MH imminent inter-domain handover towards the foreign Mobile Access Gateway (fMAG)'s access link (301); sending Hybrid_PBU message from the hLMA to the iHLMA alerting iHLMA about MH inter-domain movement (302); activating the proactive inter-domain registration and authentication by the iHLMA in advance earlier of MH roaming away from hLMA domain by transmitting the Hybrid_PBAck message comprising MH's profile and authentication information along with sets up one-way tunnel towards the foreign Local Mobile Access (fLMA) domains based on the HLCE list (303); sending a PBAck message comprising the MH's context profile by all the fLMAs neighbours that received the MH's context profile and setting up a one-way tunnel towards their access link (304); bypassing the access authentication process by comparing the MH-ID and the MH-HNP with the pre-registered MH's profile by the fMAG whenever it detects MH attachment (305); updating its record and authorising its access by sending a quick RtrAdv message with the same MH-HNP offered at the home domain by the fMAG if the MH matched with the pre-registered MH (306); completing its domain registration by the fMAG by sending a PBU message in response to the proactive PBAck message and setting up a reverse end-point tunnel towards its fLMA (307); sending the Hybrid_PBU message by the fLMA to the iHLMA in response to the Hybrid_PBAck message (308); and setting up a reverse end-point tunnel by the fLMA towards the iHLMA, which indicates the completion of the pre-registered MH's interdomain location update and offers MH's traffic access (309).

The steps of redirecting all traffic towards the MH (400) further comprising: updating MH's BCE record by the hLMA and redirecting the MH traffic through the new hMAG for intra-domain handover (401); and updating the MH's record in the iHLMA's BCE by the iHLMA and redirecting all traffic towards the MH through the fLMA's access link for inter-domain handover (402).

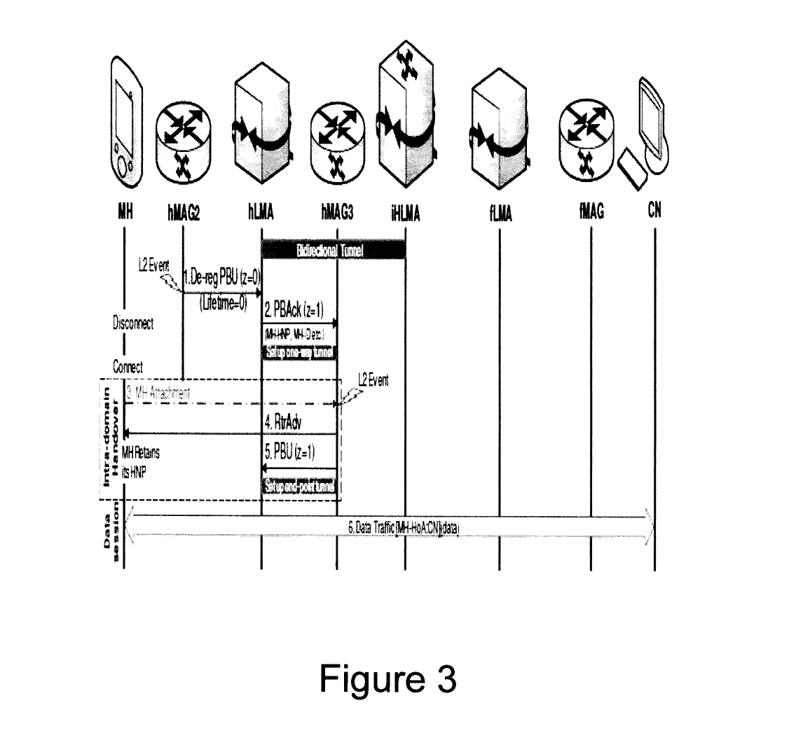

For further explanation of the present invention in the case of intra-domain handover, it is illustrated in FIG. 3 in which:

The hMAG access link sends a De-Reg PBU message to the hLMA (with zero lifetime & flag Z set to “0”). The hLMA activates the proactive intra-domain pre-registration and access authentication in advance of MH actual detachment. This is done by sending a PBAck message (with flag Z set to “1”) comprising the MH's profile with authentication information along with sets up one-way tunnel towards the new hMAGs neighbours based on the MCE list. The new hMAGs neighbours (e.g. hMAG3), which receives the MH's context information profile, it must keep the MH's information certain period of time. Then, whenever it detects the MH attachments, it will bypass the access authentication by comparing the MH-ID and MHHNP with the pre-registered MH's profile. If successfully matched, the hMAG3 updates MH's BUL entry and sends a quick RtrAdv message with same MH-HNP towards the MH to reconfigure its interface to quickly resume its data session. After that, the hMAG3 sends the PBU message to the hLMA (with flag Z set to “1” and a new lifetime) indicates to complete MH's location update. Subsequently, the hMAG3 sets up a reverse endpoint tunnel towards the hLMA offering MH's traffic access. Finally, the hLMA updates MH's BCE record and redirects the MH traffic through the hMAG3.

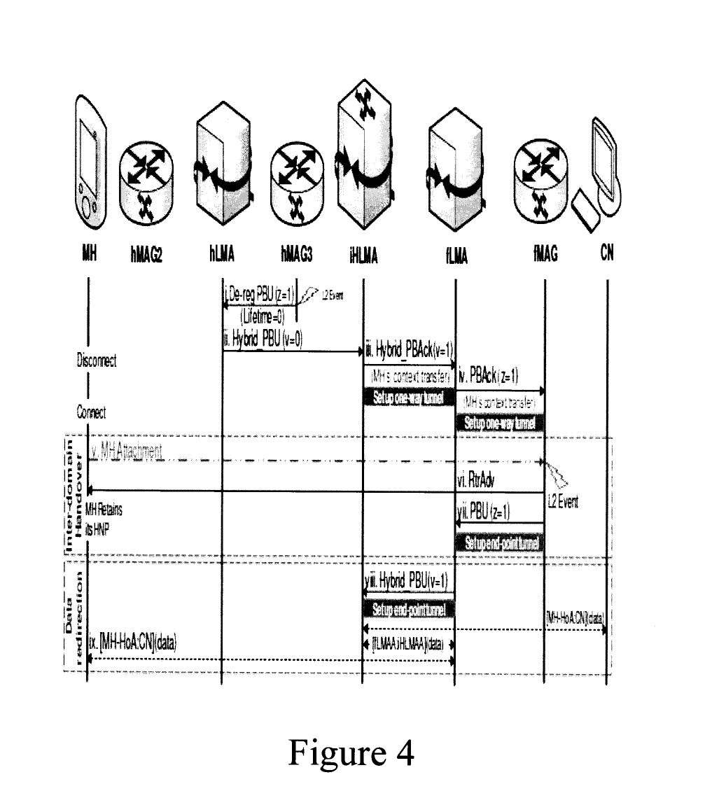

Referring to FIG. 4, in the case of inter-domain handover:

Whenever the hMAG3 senses the MH imminent inter-domain handover towards the fMAG's access link, it sends a De-Reg PBU message to the hLMA (with zero lifetime & flag Z set to “1”). The hLMA sends Hybrid_PBU message to the iHLMA (with zero lifetime & flag V set to “0”) alerting iHLMA about MH inter-domain movement. The iHLMA activates the proactive inter-domain registration and authentication in advance earlier of MH roaming away from hLMA domain. This is done by transmitting the Hybrid_PBAck message (with flag V set to “1”) comprising MH's profile and authentication information along with sets up one-way tunnel towards the fLMA domains based on the HLCE list. Then, all fLMAs neighbours that received the MH's context profile must keep the MH's information certain period of time. Subsequently, they send a PBAck message comprising the MH's context profile and set up a one-way tunnel towards their access link. Whenever the fMAG detects MH attachment, it will bypass the access authentication process by comparing the MH-ID and the MH-HNP with the pre-registered MH's profile. If this MH matched with the pre-registered MH, the fMAG updates its record and authorises its access by sending a quick RtrAdv message with the same MH-HNP offered at the home domain. Then, the fMAG completes its domain registration by sending a PBU message in response to the proactive PBAck message and sets up a reverse end-point tunnel towards its fLMA. Next, the fLMA sends the Hybrid_PBU message to the iHLMA (with flag V set to “1” and a new lifetime) in response to the Hybrid_PBAck message. Then, it sets up a reverse end-point tunnel towards the iHLMA, which indicates the completion of the pre-registered MH's interdomain location update and offers MH's traffic access. Lastly, the iHLMA updates the MH's record in the iHLMA's BCE and henceforth, redirects all traffic towards the MH through the fLMA's access link.

Although the invention has been described with reference to particular embodiment, it is to be understood that the embodiment is merely illustrative of the principles and applications of the present invention. It is therefore to be understood that numerous modifications may be made to the illustrative embodiment that other arrangements may be devised without departing from the scope of the present invention as defined by the appended claims.

1. A method for managing a low latency of handover of MH comprising the steps of:
determining imminence handover of the MH whether intra-domain or inter-domain using hybrid location tracking scheme (100);
initiating an intra-domain handover mechanism (200) if the handover is the intra-domain handoverthrough transmitting the MH's context transfer towards multiple new MAG domain based on MCE list;
initiating an inter-domain handover mechanism (300) if the handover is the inter-domain handoverthrough transmitting the MH's context transfer towards multiple fLMA domain based on the HLCE list; and
redirecting all traffic towards the MH (400).

2. A method for managing a low latency of handover of MH as claimed in claim 1, wherein the step of initiating an intra-domain handover mechanism (200) further comprising:
sending a De-Reg PBU message from hMAG access link to hLMA (201);
activating proactive intra-domain pre-registration and access authentication in advance of MH actual detachment by sending a PBAck message from the hLMA comprising the MH's profile with authentication information along with setting up one-way tunnel towards new hMAGs neighbours based on the MCE list (202);
bypass the access authentication by the new hMAG whenever it detects the MH attachments by comparing the MH-ID and MHHNP with the pre-registered MH's profile (203);
updating MH's BUL entry and sending a quick RtrAdv message with same MH-HNP by the new hMAG towards the MH to re-configure its interface to quickly resume its data session if matched (204);
sending the PBU message by the new hMAG to the hLMA indicating to complete MH's location update (205); and
setting up a reverse endpoint tunnel by the new hMAG towards the hLMA offering MH's traffic access (206).

3. A method for managing a low latency of handover of MH as claimed in claim 1, wherein the step of initiating an inter-domain handover mechanism (300) further comprising:
sending a De-Reg PBU message from the hMAG to the hLMA whenever the hMAG senses the MH imminent inter-domain handover towards the fMAG's access link (301);
sending Hybrid_PBU message from the hLMA to the iHLMA alerting iHLMA about MH inter-domain movement (302);
activating the proactive inter-domain registration and authentication by the iHLMA in advance earlier of MH roaming away from hLMA domain by transmitting the Hybrid_PBAck message comprising MH's profile and authentication information along with sets up one-way tunnel towards the fLMA domains based on the HLCE list (303);
sending a PBAck message comprising the MH's context profile by all the fLMAs neighbours that received the MH's context profile and setting up a one-way tunnel towards their access link (304);
bypassing the access authentication process by comparing the MH-ID and the MH-HNP with the pre-registered MH's profile by the fMAG whenever it detects MH attachment (305);
updating its record and authorising its access by sending a quick RtrAdv message with the same MH-HNP offered at the home domain by the fMAG if the MH matched with the pre-registered MH (306);
completing its domain registration by the fMAG by sending a PBU message in response to the proactive PBAck message and setting up a reverse end-point tunnel towards its fLMA (307);
sending the Hybrid_PBU message by the fLMA to the iHLMA in response to the Hybrid_PBAck message (308); and
setting up a reverse end-point tunnel by the fLMA towards the iHLMA, which indicates the completion of the pre-registered MH's interdomain location update and offers MH's traffic access (309).

4. A method for managing a low latency of handover of MH as claimed in claim 1, wherein the step of redirecting all traffic towards the MH (400) further comprising:
updating MH's BCE record by the hLMA and redirecting the MH traffic through the new hMAG for intra-domain handover (401); and
updating the MH's record in the iHLMA's BCE by the iHLMA and redirecting all traffic towards the MH through the fLMA's access link for inter-domain handover (402).
